(19) United States
(12) Patent Application Publication
(10) Pub. No.: US 2002/0001442 A1
(43) Pub. Date: Jan. 3, 2002

(54) Optical fiber cable

(75) Inventors: Gerard Couvrie, Calais (FR); Alain Avrons, Calais (FR); Serge Pouilly, Allemagne (FR); Vincent Bourget, Boulogne Sur Mer (FR)

Correspondence Address: SUGHRUE MION ZINN MACPEAK & SEAS, PLLC, 2100 Pennsylvania Avenue, NW, Washington, DC, 20037-3213, US

(73) Assignee: ALCATEL

(21) Appl. No.: 09/864,264

(22) Filed: May 25, 2001

(30) Foreign Application Priority Data
May 29, 2000 (FR) 00 06 837

(51) Int. Cl. G02B 6/44

(52) U.S. Cl. 385/110; 385/111; 385/113

(57) ABSTRACT

The invention relates to an optical fiber cable comprising a core having at least one helical groove in its periphery, at least two assembled-together flexible tubes placed in the groove, each flexible tube containing a plurality of optical fibers, and a flexible material placed between the flexible tubes and the bottom of the groove. The core is surrounded by means for providing protection against external agents, e.g. an aluminum tape or a tube of plastic material. Stiffening means such as armoring wires surround the assembly.

The present invention relates to an optical fiber cable, more particularly to an optical fiber cable of compact structure comprising a grooved core having packets of optical fibers placed in its grooves.

### BACKGROUND OF THE INVENTION

Overhead optical fiber cables are laid in particular above high voltage power lines, in or around the static or ground wires (i.e. cables that act as lightning conductors).

DE-A-3 742 925 describes an optical fiber cable comprising a central steel wire surrounded by an intermediate layer of filamentary elements which is itself surrounded by an outer layer of steel wires. Some of the filamentary elements of the intermediate layer are constituted by steel wires while the others are optical elements each constituting a tube of plastics material containing optical fibers. In other words, some of the steel wires in the intermediate layer are replaced by optical elements.

The optical capacity of the cable, i.e. the number of optical fibers it includes, is limited by the fact that substituting steel wires with optical elements reduces the traction strength of the cable. The reduction in traction strength can be compensated by adding one or more additional layers of steel wires, but that has the drawback of increasing the diameter of the cable and of increasing its cost.

U.S. Pat. No. 4,944,570 describes an optical fiber cable comprising a core with helical grooves. Each groove has fitted therein a flexible dielectric tube containing one or more optical fibers. The tube also contains a flexible water repellent dielectric compound that contributes to holding the optical fibers in position while still allowing them to move. The core is covered in a tape of aluminum and surrounded by conductive wires which provide the major fraction of the cable's mechanical strength. In a variant, the aluminum tape is replaced by a protective tube of plastics material and another protective tube of plastics material is placed around the conductive wires if the cable is to be used under water. That cable structure defines a traction window which depends on the ability of the optical fibers to move inside the helical tubes containing them.

To obtain large optical capacity, it is necessary to increase the number of tubes, and thus the number of grooves in the core and/or the number of optical fibers contained in each tube, and that has the drawback of increasing the diameter of the core and correspondingly the diameter and/or the number of the conductive wires.

### OBJECTS AND SUMMARY OF THE INVENTION

An object of the present invention is to eliminate the drawbacks of the prior art, and in particular it seeks to provide an optical fiber cable having large optical capacity for a cable of limited size.

To this end, the present invention provides an optical fiber cable comprising:

an aluminum or aluminum alloy core including at least one helical groove in its periphery;

at least two flexible tubes assembled together and placed in the groove, each flexible tube containing at least one optical fiber;

a flexible material placed between the flexible tubes and the bottom of the groove;

protective means surrounding the core and providing protection against penetration of external agents; and

stiffening means surrounding said protective means, the core, the protective means and the stiffening means being compatible, electrochemically.

The core may have a plurality of helical grooves at its periphery with at least two assembled-together flexible tubes being placed in each of the grooves.

In a preferred embodiment, a flexible hydrophobic compound can advantageously fill the groove.

Furthermore, the stiffening means can comprise a plurality of stranded wires, which are advantageously aluminum-coated steel wires.

In this preferred embodiment, it is advantageous for the protective means to comprise at least one tape wound helically around the core and overlapping from one turn to the next, the tape(s) advantageously being made of aluminum or aluminum alloy. The cable is then particularly suited for use as a static wire on power line pylons. In a variant, the protective means can comprise a protective tube placed around the core, and preferably made of metal or plastics material. In which case, the cable can also have a sheath placed around the stiffening means, the sheath being preferably made of plastics material. In addition, a flexible hydrophobic compound can advantageously be placed in the gap between the protective tube and the sheath. This variant of the cable is particularly adapted to underwater conditions.

In another preferred embodiment, the stiffening means comprise a fiber-based material and a protective tube surrounds the stiffening means. This embodiment of the cable is particularly adapted for use in boreholes in the ground.

### BRIEF DESCRIPTION OF THE DRAWING

Other characteristics and advantages of the invention will appear on reading the following description of a preferred embodiment of the invention, given by way of example and with reference to the accompanying drawing.

FIG. 1 is a diagrammatic right section of an optical fiber cable constituting an embodiment of the invention.

### MORE DETAILED DESCRIPTION

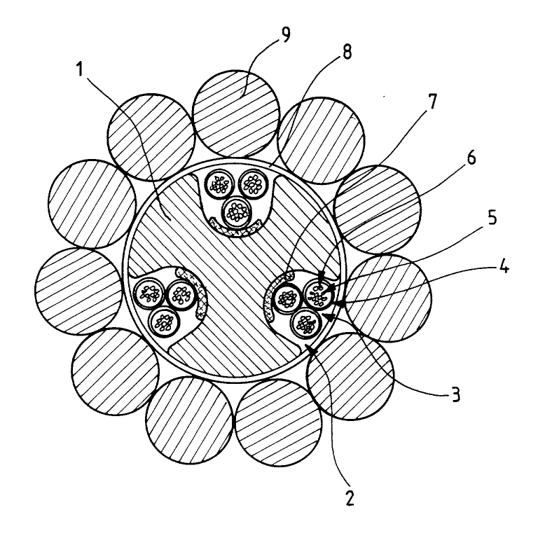

The optical fiber cable of FIG. 1 comprises a core 1 having a preferably circular right section whose periphery has one or more grooves 2 formed therein (three grooves being shown in the example of FIG. 1). The grooves 2 turn helically around the core 1, either with a left-hand pitch or with a right-hand pitch, or indeed with a pitch that reverses regularly. The grooves 2 are preferably placed at regular angular intervals around the periphery of the core 1 when seen in right section, and the number of grooves 2 is advantageously two, three, or four. The core 1 is preferably made of aluminum or aluminum alloy. In addition to carrying electricity, the core 1 serves to withstand radial mechanical forces exerted thereon, and in particular to provide mechanical strength against flattening that is sufficient to protect the optical elements placed in the grooves. The cross-section and the pitch of the grooves 2 relative to the diameter of the core 1 is suitable for ensuring that the core 1 acts substantially as a solid rod.

An optical module 3 is placed in each of the grooves 2. An optical module 3 comprises a plurality of flexible tubes 4 (there being three in the example shown in FIG. 1) assembled together, preferably in a helical configuration having either a left-hand pitch, or a right-hand pitch, or a pitch that reverses regularly, known as an S-Z lay.

Each of the flexible tubes 4 contains one or more optical fibers 5 (there are twelve in the example of FIG. 1), that are left free inside the flexible tube. A flexible dielectric gel or a powder that swells can be provided. The gel 6 is selected to enable the optical fibers 5 to move relative to one another without friction and to constitute a barrier that protects the optical fibers 5 against water, humidity, chemical agents, and abrasive dust that might penetrate into the flexible tube 4 in the event of the tube being torn. The gel 6 also presents temperature behavior suitable for withstanding the temperatures to which it might be subjected in a cable. Typically, the gel 6 can be a thixotropic and hydrophobic gel presenting thermal and chemical stability over time, such as a petroleum jelly or a silicon gel.

Each of the flexible tubes 4 is made of a flexible dielectric material that is extrudable with thin walls and that presents sufficient ability to withstand handling (resistance to tearing, traction strength, . . .) to enable it to be assembled with the other tubes 4, and to enable the assembly to be put into place in the grooves 2 of the core 1. This material also has a melting temperature that is high enough to ensure that the flexible tubes 4 are not affected by the temperatures that the cable can reach because of thermal heating associated with the electrical loads it carries. For example, the flexible tubes 4 can be made of PVC, polyester ether, polypropylene, or EVA (ethylene vinyl acetate copolymer). The materials can contain fillers, e.g. chalk, silica, talc, or other conventional mineral fillers. The wall thickness of the flexible tubes 4 advantageously lies in the range 0.05 millimeters (mm) to 0.4 mm.

Each of the optical modules 3 is placed in the corresponding groove 2 without projecting beyond the periphery of the core 1. In addition, a flexible material 7 is placed between the bottom of each groove 2 and the optical module 3 which is placed therein. This flexible material 7 which is preferably a dielectric, serves to space the optical module 3 apart from the bottom of the groove 2 during manufacture of the cable. This clearance between the bottoms of the grooves 2 and the optical modules 3, combined with the flexibility of the material 7 enables each of the optical modules 3 to move radially towards the bottom of the corresponding groove 2 in such a manner as to accommodate elongation of the cable while it is being laid on site, e.g. on pylons. The material 7 can be a gel, a flexible adhesive, or a foam. Naturally, the grooves 2 are of a shape that is suitable for allowing the respective optical modules 3 they contain to move radially, and for this purpose, they preferably have flanks that are parallel and spaced apart by a distance that is not less than the width of an optical module 3. Consequently, neither the flexible tubes 4 nor the optical fibers 5 are subjected to any significant increase in traction stress when the cable lengthens, providing it remains within the traction window defined in this way. The term “traction window” is used to designate the relative elongation of the cable that is necessary before elongation starts to give rise to any significant increase in the stresses in the optical fibers 5. The value of the traction window will depend in particular on the maximum amount of radial displacement available for the optical modules 3 in their respective grooves 2, and on the helical pitch formed by each of the grooves 2.

The core 1 can be covered by one or more tapes 8 of aluminum or aluminum alloy, applied helically around the core 1 and overlapping from one turn to the next. The tape(s) 8 provide the core 1 and the optical modules 3 with mechanical protection and also with protection against external attack such as penetration of water, humidity, chemical agents, dust . . . The tape 8 also provides electrical contact between the armoring wires 9 placed around the tape 8 and the core 1. Aluminum is selected as a material for the tape 8 so as to ensure that it is chemically compatible with the core 1 and thus avoid electrolytic corrosion between them. The hydrogen that can be generated in the flexible tubes 4 can escape through the gel 6, and then through the walls of the flexible tubes 4, so as to depart finally through the overlap zones of the tape 8, thus minimizing the concentration of hydrogen around the optical fibers 5 and thus limiting optical attenuation in the fibers, it being understood that the material of the flexible tubes 4 and of the gel 6 presents only traces of hydrogen under the operating conditions of the cable.

The armoring wires 9 (there are eleven of them in the example of FIG. 1) are stranded around the tape 8 and withstand the major fraction of traction forces that are applied to the cable. The armoring wires 9 also serve as electrical conductors for conveying electricity, e.g. that can arise from lightning when the cable is installed on pylons. The armoring wires 9 are advantageously made of aluminum-coated steel (ACS). The aluminum coating of the wires 9 provides excellent electrical conductivity and is electrochemically compatible with the tape 8, thus avoiding electrolytic corrosion. The steel cores of the wires 9 give them mechanical strength. The diameter and number of armoring wires 9 is determined as a function of the mechanical stresses to be withstood and as a function of the maximum electrical current to be conveyed, with account also being taken of the thickness of the aluminum coating.

In a variant, the grooves 2, each containing their respective optical modules 3 and flexible material 7, can be further filled with a gel that is similar or identical to the gel 6. This gel 6 facilitates relative frictionless movements between the flexible tubes 4 and the walls of the grooves 2 and constitutes an additional barrier protecting the flexible tubes 4 against water, humidity, chemical agents, and abrasive dust that can penetrate into the grooves 2 in the event of the tape 8 being torn. Furthermore, it is also possible for the aluminum tapes to be replaced by a seamed metal tube or any other solution that serves to protect the core.

The optical fiber cable can be made as follows. The flexible tube 4 is extruded around the optical fibers 5. The gel 6 and the powder, if any, are introduced into the tubes during extrusion.

The flexible tubes 4 are assembled together helically or in an S-Z configuration to form optical modules 3. The flexible material 7 is put into place at the bottom of each groove 2 in the core 1 followed by the corresponding respectively optical module. Where appropriate, the grooves 2 are filled with gel. Thereafter, the aluminum tape 8 is placed around the core 1, and finally the armoring wires 9 are stranded around the core 1.

By way of example, the cables can have the following dimensions. The core 1 has an outside diameter of 7 mm and presents three helical grooves 2 each having a width of 2.7 mm, and the bottoms of the grooves lie on an imaginary circle having a diameter of 2.5 mm disposed coaxially with the core 1. Each groove 2 contains an optical module 3 comprising three flexible tubes 4 each having a diameter of 1.3 mm and containing twelve optical fibers. Each flexible tube 4 is made of polypropylene and has a wall thickness of 0.15 mm. The core 1 is surrounded helically by two aluminum tapes that are 0.15 mm thick. Finally, the assembly is surrounded by eleven armoring wires each having a diameter of 2 mm. The resulting cable is about 12 mm in diameter.

The embodiment described with reference to FIG. 1 is particularly adapted for use as an overhead cable, and more particularly still as a static wire on power line pylons. In a variant, it is possible to omit the aluminum tape 8 when environmental conditions make that possible.

In another embodiment, the optical fiber cable described with reference to FIG. 1 can be adapted for use as an underwater cable (under sea, under river, . . .). For this purpose, it suffices to replace the aluminum tape 8 with a protective tube that is placed around the core 1 and made of an extrudable thermoplastic material such a polyethylene or polyvinyl chloride (PVC) or indeed by a metal tube. In addition, an outer protective sheath is added around the armoring wires 9. This sheath can be made of an extrudable thermoplastic material such as polyethylene or PVC, or indeed out of any suitable material such as impregnated jute fabric. Naturally, the tube and the sheath also provide waterproofing. Finally, the gaps between the armoring wires 9 in the space between the protective tube and the sheath can be filled with a flexible hydrophobic gel, for example a gel of the type used inside the tubes 3.

In yet another embodiment, the optical fiber cable described with reference to FIG. 1 is adapted as follows. The aluminum tape 8 and the armoring wires 9 are omitted. One or more fiber-based stiffening elements are applied longitudinally, braided, or wound helically around the core 1. The stiffening elements can be made of polyaramid fibers. An outer protective tube is placed around the above-mentioned stiffening elements. The protective tube is preferably made of an extrudable thermoplastic material such as polyethylene or PVC or indeed of suitably impregnated jute fabric. This type of cable can be used in particular in drilling applications such as oil prospecting where it is used for making connections with sensors.

Naturally, the present invention is not limited to the examples and embodiments described and shown, and it can be varied in numerous ways by the person skilled in the art. In particular, conductive materials other than aluminum can be used for the core 1, the tape 8, and the coating on the armoring wires 9.

1. An optical fiber cable comprising:
an aluminum or aluminum alloy core including at least one helical groove in its periphery;
at least two flexible tubes assembled together and placed in the groove, each flexible tube containing at least one optical fiber;
a flexible material placed between the flexible tubes and the bottom of the groove;
protective means surrounding the core and providing protection against penetration of external agents; and
stiffening means surrounding said protective means, the core, the protective means and the stiffening means being compatible, electrochemically.

2. The cable of claim 1, wherein the core has a plurality of helical grooves at its periphery with at least two assembled-together flexible tubes being placed in each of the grooves.

3. The cable of claim 1, wherein a flexible hydrophobic compound fills the groove.

4. The cable of claim 1, wherein the stiffening means comprise a plurality of stranded wires.

5. The cable of claim 4, wherein the stranded wires are made of aluminum-coated steel.

6. The cable of claim 1, wherein the protective means comprise at least one tape placed helically around the core and overlapping from one turn to the next.

7. The cable of claim 6, wherein the tape(s) is made of aluminum or aluminum alloy.

8. The cable of claim 1, wherein the protective means comprise a protective tube placed around the core, preferably made of metal or plastics material.

9. The cable of claim 8, having a sheath placed around the stiffening means, the sheath being preferably made of plastics material.

10. The cable of claim 9, wherein a flexible hydrophobic compound is placed in the gaps between the protective tube and the sheath.

11. The cable of claim 1, wherein the stiffening means comprise at least one fiber-based material and wherein a protective tube surrounds the stiffening means.

12. The use of the cable of claim 1 as a static wire on a power line pylon.

13. The use of the cable of claim 8, in underwater conditions.

14. The use of the cable of claim 11, in a borehole in the ground.
